(19) United States
(12) Patent Application Publication
(10) Pub. No.: US 2004/0245043 A1
(43) Pub. Date: Dec. 9, 2004

(54) Waveguide louspeaker with adjustable controlled dispersion

(76) Inventors: Guido Noselli, Flero (IT); Stefano Noselli, Flero (IT)

Correspondence Address: MCGLEW & TUTTLE, PC, 1 SCARBOROUGH STATION PLAZA, SCARBOROUGH, NY, 10510-0827, US

(21) Appl. No.: 10/491,267

(22) PCT Filed: Sep. 23, 2002
(86) PCT No.: PCT/IT02/00605

(30) Foreign Application Priority Data
Oct. 3, 2001 (IT) BS01A000073

(51) Int. Cl. G10K 11/00

(52) U.S. Cl. 181/176; 181/186; 181/191

(57) ABSTRACT

The invention relates to a waveguide loudspeaker with adjustable controlled dispersion which comprises a duct fonned by flat, concave or convex walls round a diffraction throat, and which finishes in a mouth and where reflection can occur before or after the diffraction throat. The mouth is folded back in relation to the throat and has dimensions and shape chosen for the simultaneous application of at least two of the three fundamental principles for sound diffusion, namely diffraction, reflection and absorption. Also, the invention concerns a method to obtain a loudspeaker having means to vary and set at least the degree of diffraction and reflection for the reproduction of wide bands of mid/high frequencies with a limited horn or waveguide length.

### FIELD OF THE INVENTION

This invention regards in general the loudspeaker enclosure sector, and refers in particular to horn loudspeakers for these enclosures.

### STATE OF THE ART

Horn loudspeakers in the strict sense of the word are to this day widely used for their particular features of efficient sound dispersion control, especially in the professional amplification sector, in which it is increasingly important to obtain high directivity and precise dispersion to facilitate acoustic coupling free from interference between loudspeaker enclosures in multiple systems.

Their use is in any case limited by their dimensions, which, being closely related to the low frequency which they can usefully reproduce and the necessary dispersion, are sometimes much larger than those wanted or required for the type of loudspeaker enclosure in which they are to be fitted.

A large mouth area for the reproduction of low frequencies, for example, corresponds to a considerable horn length to the throat, due to the very slow expansion, which the reproduction of this band of frequencies requires, depending on the relative wavelength.

Various methods have been thought up to reduce at least one of horns'dimensions, the length; such as, for example, constructing the horn according to an expansion of the areas, classically exponential in the initial part of the duct, but then flaring much more rapidly, in order to form a much shorter overall duct with the same mouth area (for example Tractrix or Wilson's horn). However, the one which prevailed, and is still the most widespread, consists in folding the horn back on itself in various ways, to obtain an external dimension as far as depth or length of the duct is concerned is as compact as possible, depending on the performance required.

Nevertheless, although well known and successfully applied for the construction of low frequency horns, this technique has not been applied in the same way for the reproduction of mid and high frequencies, starting for example from 500 Hz up to the highest frequencies limits audible to the human ear, 15/20 kHz.

This is due to the fact that up until now a folded horn has not been found, which, while maintaining the ability to reproduce the lowest frequencies by means of a preset “cut-off” or lowest usefully reproduced frequency, doesn't destroy the higher part of the aforementioned frequency band, for example from 2000 Hz upwards, even before these frequencies reach the horn mouth to be fed out, therefore doesn't allow to disperse the sound evenly and free from defects in the precise dispersion angle required.

This fact has precluded the great advantages which the adoption of folded horns for reproducing mid/high frequencies would enable in terms of efficiency and compact dimensions, which on the other hand the same technique has brought for low frequencies in sound reinforcement systems, particularly professional ones.

### OBJECTS AND SUMMARY OF THE INVENTION

This invention intends overcoming this restriction with the realization of a folded horn effectively suited to mid/high frequencies, while maintaining limited dimensions and footprint for ease of use.

Another object of the invention is to offer a horn which, for its unconventional form and dimensions, is adaptable to various types of loudspeaker enclosures.

Another object of the invention is to offer a horn able to control the sound dispersion angle precisely, even if for its unconventional form and dimensions it is able to be adapted to different types of loudspeaker enclosures.

Another object of the invention is to offer a folded horn suitable for enabling to realize freer, less bulky forms of loudspeaker enclosures for mid/high frequency bands.

These objects of the invention and the implicit advantages which result from them have been achieved with the choice of the horn shape, based on the simultaneous application and therefore the inclusion of at least two of the three known acoustic principles: diffraction, reflection and absorption.

The definition of “horn” in the traditional sense of the term seems less suitable here than “waveguide” in a wide sense, as the object of the invention isn't geometrically built according to the usual mathematical rules involved in horns. Therefore, the object of the invention is hereafter called precisely “waveguide”.

According to the invention, the waveguide can be built with various forms and dimensions, suited on each occasion to the choices of design regarding the loudspeaker enclosure in which it must be mounted in its entirety, in a simple practical way, respecting the application of the aforementioned principles.

In fact, only by combining two or all three of these principles is it possible to maintain the efficiency and control of directivity, better than with a so-called constant-directivity horn, with a form and dimension which differs greatly from the traditional criteria established through time for these types of horns, such as conical, exponential, hyperbolic and all the other types based on their combination or partial modification.

### BRIEF DESCRIPTION OF THE DESIGNS

The invention will be better explained in the continuation of the description, done referring to the attached designs, which are indicative and not restrictive, and in which:

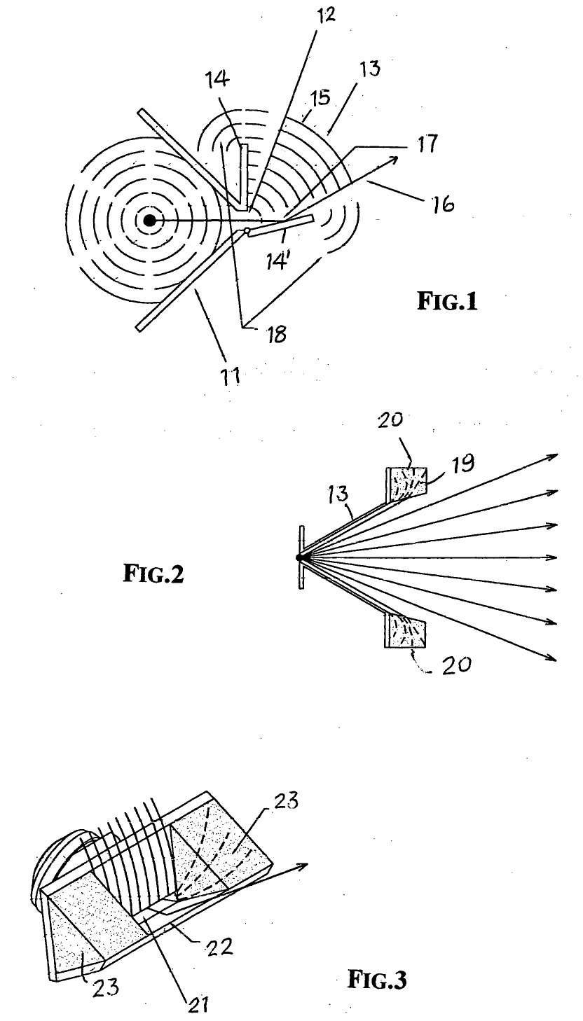

FIG. 1 is a schematic illustration of the principles of diffraction and reflection;

FIG.2 is a schematic illustration of the application of the principle of absorption;

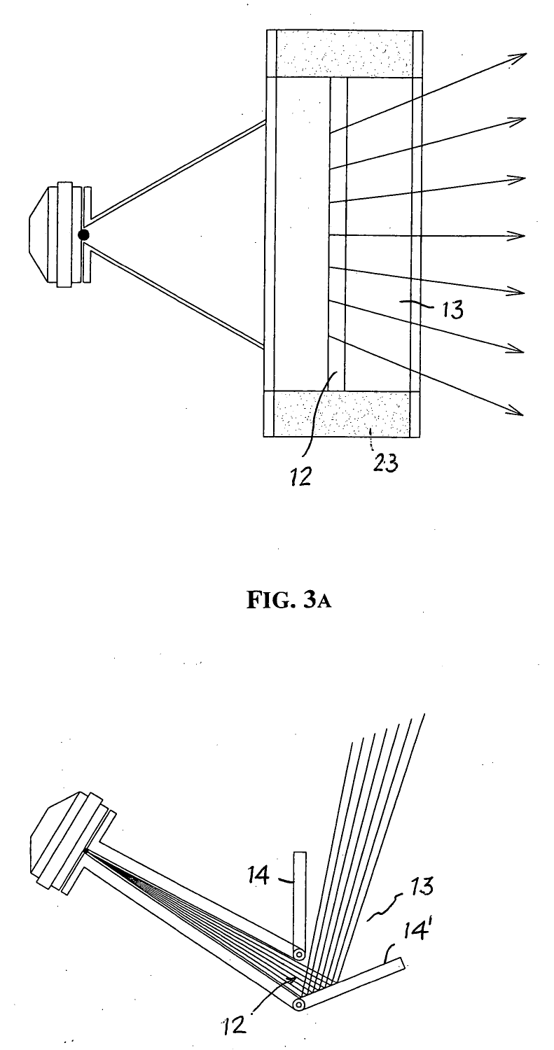

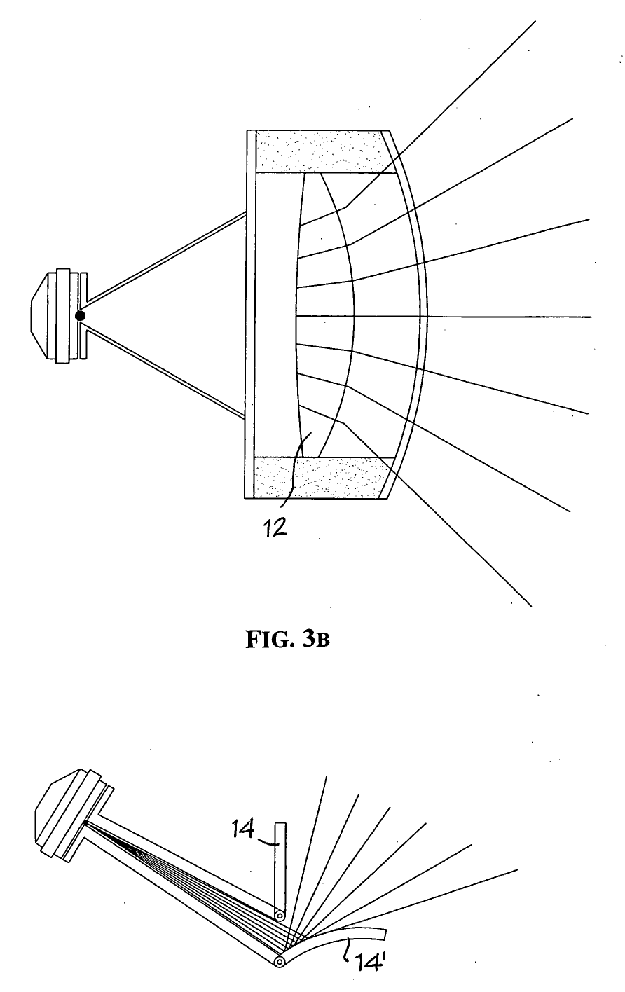

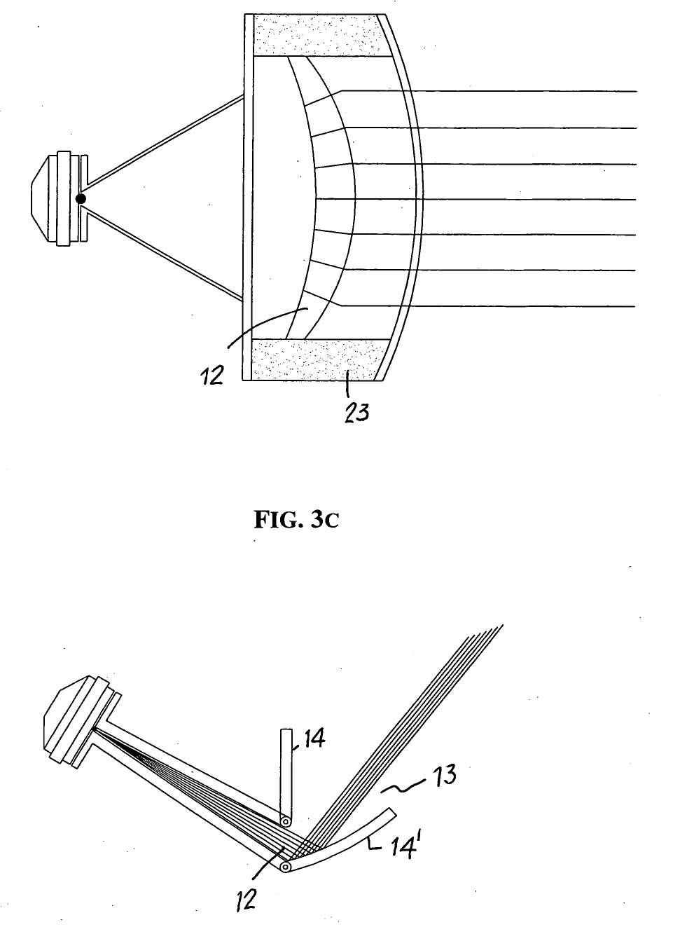

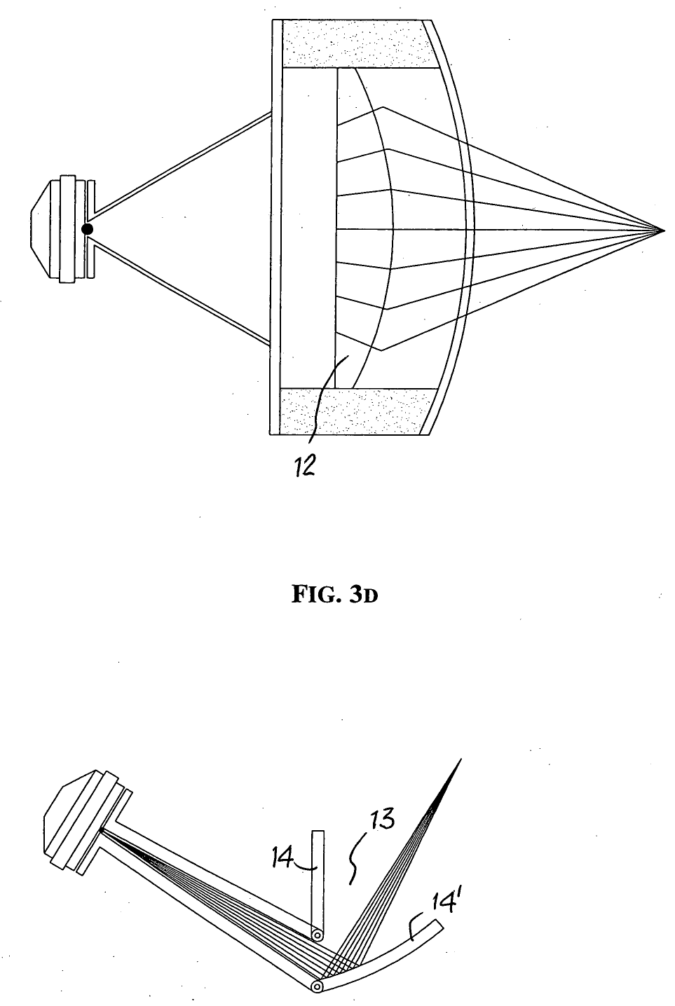

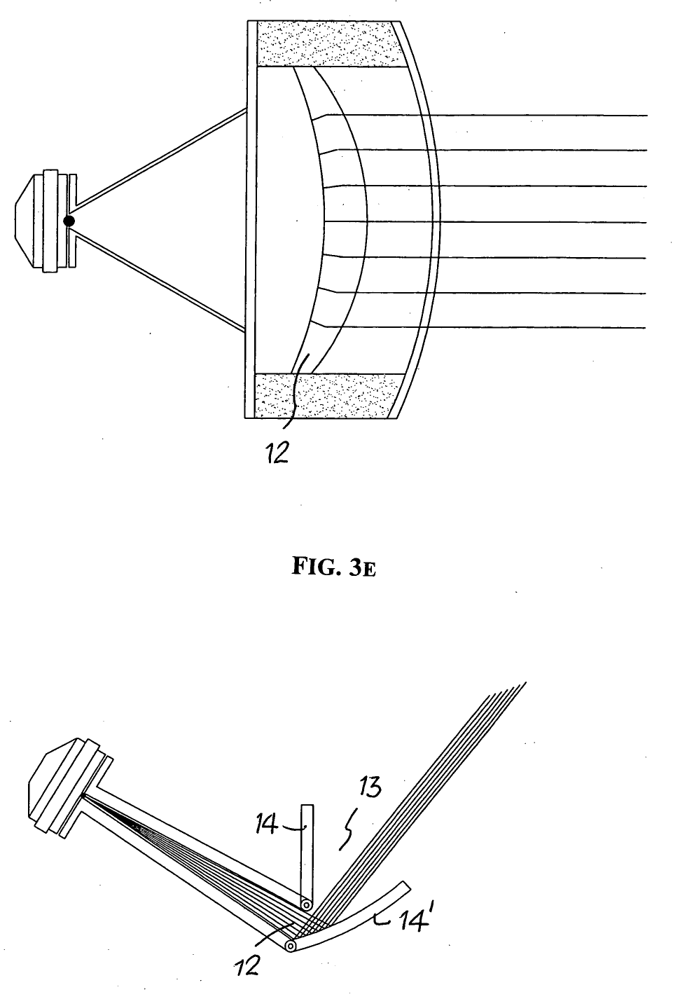

FIG. 3 is an illustration of the combination of the three principles of diffraction, reflection and absorption in an example of folded waveguide;

FIG. 3A, 3B, 3C, 3D and 3E are schematic illustrations in two simplified views (cross-section and overhead) for each of the different effects of reflection with reference to the geometry of the reflecting surface which defines the sound dispersion.

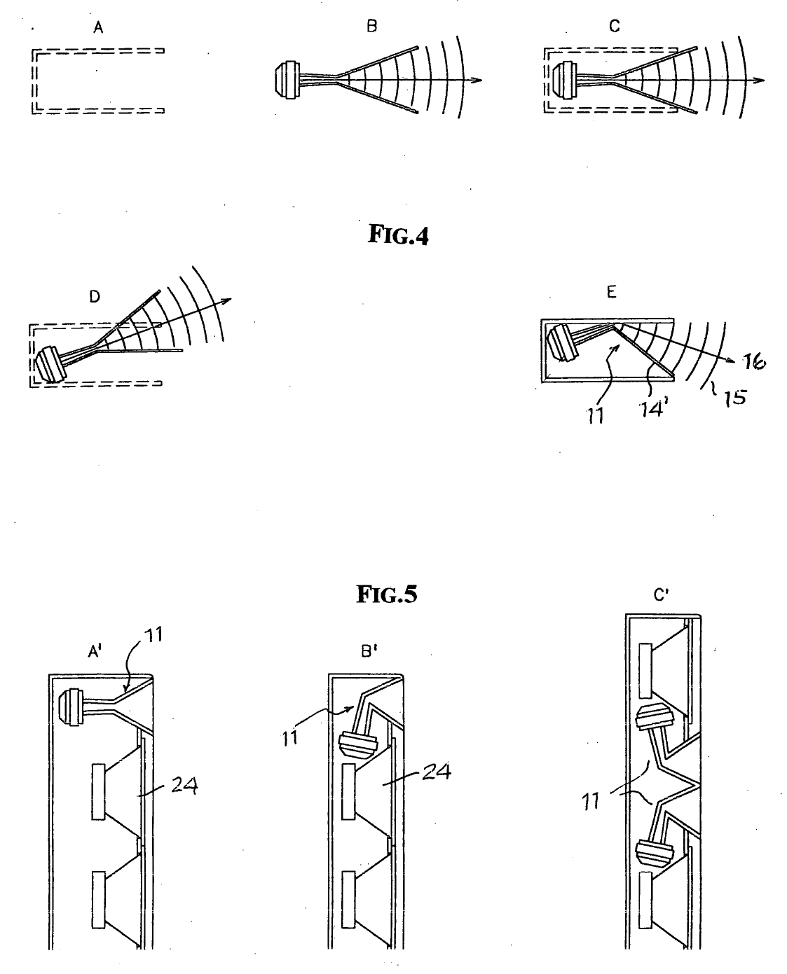

FIG. 4, A, B, C D and E show one of many example of adaptation of the folded waveguide to a preset space, with the application of the principles of diffraction and reflection;

FIG. 5, A, B and C show a schematic illustration of a folded waveguide compared with a straight one, applied to traditional loudspeaker enclosures or those suitable for forming vertical or horizontal arrays;

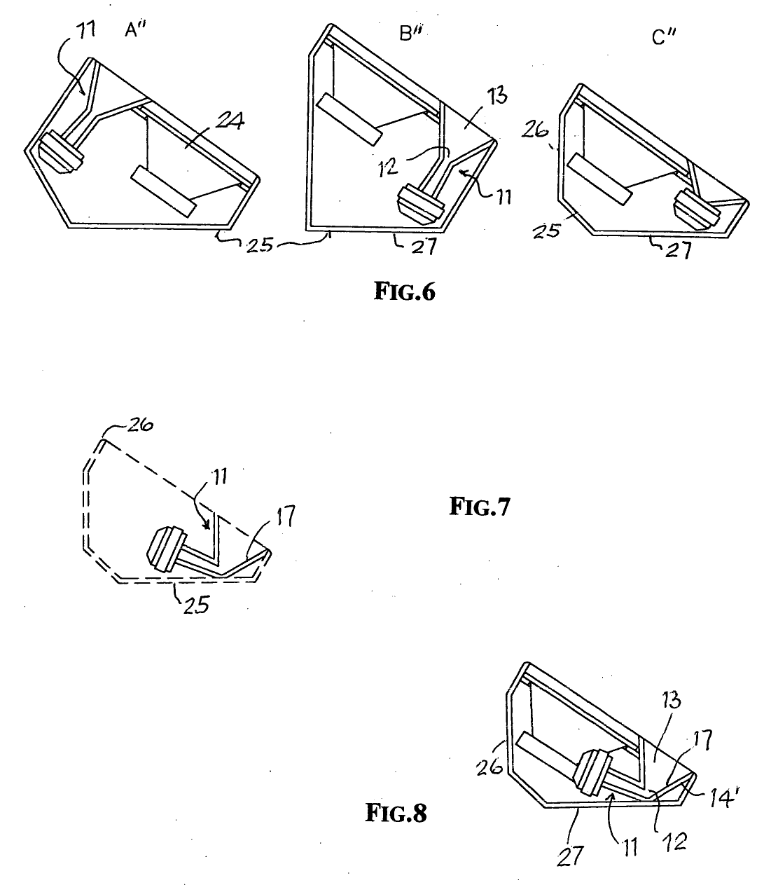

FIG. 6, A, B and C shows a schematic illustration of various types of traditional (A and B) and low profile (C) stage monitors;

FIG.7 is a schematic cross-section of the folded waveguide mounted in a stage monitor;

FIG. 8 is a schematic cross-section of the same waveguide and the other components necessary for a stage monitor's operation;

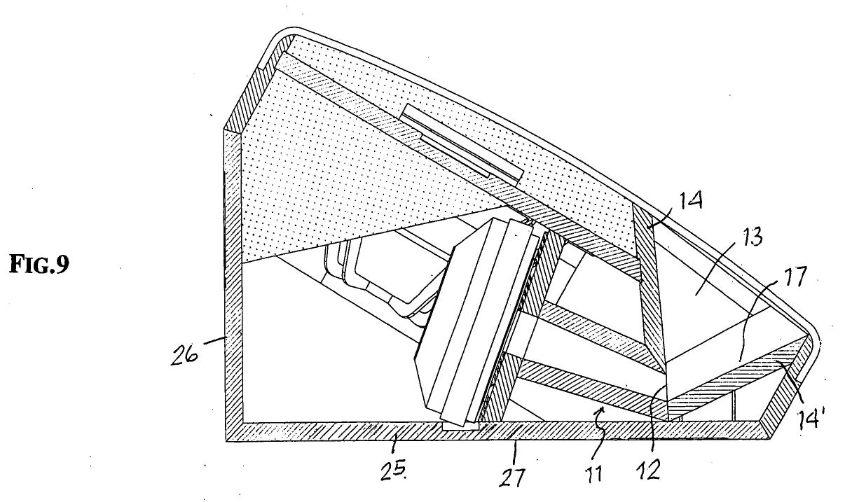

FIG.9 is a schematic cross-section view of a practical realization of a loudspeaker enclosure;

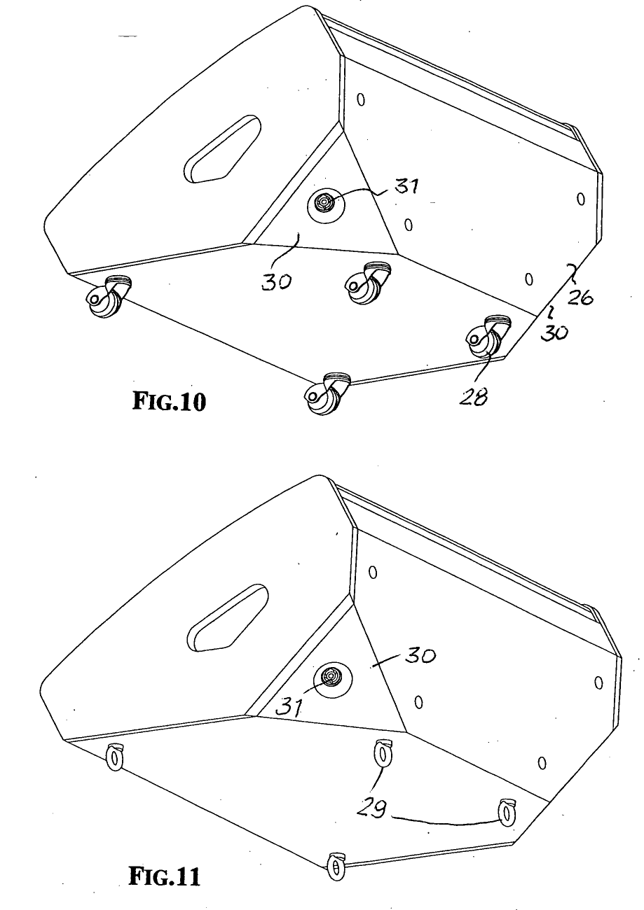

FIG. 10 is the rear view of a loudspeaker enclosure with castors;

FIG. 11 is the same view of a loudspeaker enclosure with eyebolts or flying rings.

### DETAILED DESCRIPTION OF THE INVENTION

In FIG. 1 there is represented an adjustable waveguide (11) in which the principles of diffraction and reflection are applied. The waveguide (11) has a diffraction slot (12), followed by an expansion section forming a mouth (13). This mouth is formed by walls (14), at least one of which (14′) has an inclination which can be varied by means of a hinge, or choosing the aperture angle at the origin. In it, the sound waves which pass through in the wavelength band (15) larger than the dimensions of the diffraction slot are diffracted and fed by the walls of the waveguide (this is the case for wavelengths smaller than the emission mouth), while the band of wavelengths (16) smaller than the diffraction slot are reflected by at least one reflection surface (17) formed by the wall (14′) which, according to needs to direct the sound, can be flat, concave or convex in all known geometric variations as shown in FIG. 3A, 3B, 3C, 3dD and 3E, with the possibility of adjusting its direction by changing the inclination of the actual wall. The band of diffracted frequencies with a larger wavelength (18) than the dimension of the mouth (13) is eliminated at its edges with an appropriate electrical cut.

FIG. 2 illustrates the application of the principle of absorption, with which the sound waves (19), produced by the diffraction at the edges of the mouth (13), because they have frequencies with a wavelength similar to the dimensions of the actual mouth and the sound waves with a smaller wavelength than the dimension of the mouth, which anyway strike the surface of the absorbent material (20) used for the application of the principle, are absorbed.

FIG.3 shows a folded waveguide with a diffraction throat (21), a flat, concave or convex reflection wall (22), as and with the effects shown in FIG. 3A, 3B, 3C, 3D, 3E and absorbent material (23) at the sides, illustrating the combined application of the three principles: diffraction, reflection and absorption.

FIG. 4 shows an example of the adaptation of a folded waveguide (11) to a preset space. Starting with a container with a maximum useable cross-section (A), a horn (B) is calculated with acoustic design parameters to be physically mounted in the space of the available cross-section A, as shown in C, and a check of the positioning in this space as in D. Again in FIG.4, E shows a solution of folded waveguide according to the invention, entirely contained in the initial container and which keeps the performance practically unchanged or similar.

FIG. 5 shows a folded waveguide, compared with the equivalent straight version, (11) mounted in traditionally shaped loudspeaker enclosures (A, B and C) of the type suited for forming vertical or horizontal line arrays. In this FIG.5, the waveguide(s) (11) are combined with the respective loudspeakers (24) according to different layouts which allow to achieve acoustic performance similar to or better than that of traditional horns, although adapting themselves to less deep containers or enclosures, as shown in detail in B and C.

In order to better highlight the concept of this invention, a non-restrictive example is given, with a particular loudspeaker enclosure (25), intended for the precise function of professional sound reinforcement, in which, via the adoption of the waveguide which is the subject of the invention, designed in respect of the aforementioned principles, the required objectives are achieved; suitable for use in terms of dimensions, performance and shape and advantages which can be achieved.

Nowadays in some shows (from modern music concerts to television transmissions, etc.), extensive use is made of specialized loudspeaker enclosures to enable artists and protagonists, or even the audio technicians involved, to hear or “monitor” their own performance in real time and/or that of the others, in order to optimise the overall artistic result.

These loudspeaker enclosures are commonly called monitors or stage monitors, as they are most frequently positioned on-stage.

For this reason, they normally have a body or box (26) with a shape which is neither parallelepiped nor cubic, but geometrically designed and built in such a way as have the front panel, where the loudspeakers (24) are fitted, always (obviously) pointed at the artist's or listener's face. The shape is generally designed in order for the body (26) of the loudspeaker enclosure (25) to have a base (27) standing on the floor (FIG.6 A, B and C).

The loudspeaker enclosure described will therefore necessarily have the front inclined in relation to the underside, according to the angle or angles, as the layout sometimes foresees more than one, according to the construction chosen by the designer.

Another geometric peculiarity necessary for this type of loudspeaker enclosure is compact overall dimensions, but above all low profile in the sense of a reduced height in relation to the side standing on the stage, which (as the monitor is positioned between the artist and the audience), doesn't jeopardize the possibility of the latter of enjoy the show without any visual obstructions. This feature also greatly facilitates the monitor's camouflage, greatly appreciated by set designers, directors and the artists themselves.

Up until now, these features, based on users'requests, have greatly limited the performance of this type of so-called low profile loudspeaker enclosure, due to the compact dimensions, as far as height is concerned, compared to those required for mounting horns, which, as has already been said, are necessarily long and have wide mouths to ensure high level acoustic performance, or as are required from a loudspeaker enclosure for professional use, especially from the point of view of sound pressure and dispersion control.

In fact, these types of low profile monitors normally use very small short horns which don't allow loading which is acoustically favourable to the reproduction of mid-range frequencies typical of the human voice, with the result that this range is reproduced by unsuitable loudspeakers, such as the dynamic models with large cones (usually in paper) and therefore not sufficiently precise and often unable to reproduce the voices they amplify with the required intelligibility (FIG. 6, C″).

As well as this the loudspeaker enclosures designed in this was, with every compromise based above all on the height (low profile), don't have the necessary very important feature of directivity control in the range of frequencies typical of the human voice, once again due to the fact that they can only be fitted with a small horn.

This last negative aspect also makes their use risky due to problems of feedback with the microphone of the artist or speaker who is in front of them, to the extent that only by lowering the volume fed out by the monitors themselves considerably is it possible to use them. This however greatly contrasts with the fundamental required from monitors, which is obtaining a high volume before feedback with the purpose of being heard over all the rest of the reproduced sound at that moment being reproduced by the main sound system: the signal is in fact sent to the monitor for this very purpose.

In other words, the realization of a “low profile monitor” generally implies a considerably poorer performance than other types of monitor, where height doesn't have to be limited.

This invention on the other hand overcomes all the problems of size and acoustic problems based on them, thanks to the folding of the waveguide used (FIG. 7), obtaining maximum acoustic performance without any comprise caused by dimensions, which are exceptionally compact thanks to the invention's characteristics. In fact, the application of the aforementioned acoustic principles, by means of the use of different reflecting surfaces, allows this particular “waveguide” to be constructed on each occasion, with suitable form and dimensions for the loudspeaker enclosure in which it's mounted, irrespective of the its type or functionality (FIG.5, B and C, FIG.8; FIG.9), with required directivity characteristics established not only by the dimensions themselves, as is the case with conventional horns, but precisely from the effects of these principles, combined and set by the designer for the realization of loudspeaker enclosures for use in multiple set-ups, positioned alongside one another or above on another in vertical or horizontal arrays, without the occurrence of the detrimental interference phenomena typical of the poor or inexistent directivity of traditional compact systems -FIG. 5B and 5C.

In FIG. 7, 8 and 9, it can be seen how the mere fact of folding the waveguide meets the requirements for reducing the dimensions of low profile monitors and stage monitors, even with higher acoustic performance and passband.

On last advantage worth noting (FIG. 10 and 11) is that the body and box of a loudspeaker enclosure fitted with at least one waveguide 11 can have castors (28) or eye-bolts (29) mounted on its base to facilitate handling and transport, and the corners between the base and the rear panel have special rounded shape (30), where right angle connectors (31) can be fitted in a recessed protected position, without having any effect on the space occupied.

1. A method for realizing waveguide loudspeaker for loudspeaker enclosures, where the waveguide has a duct formed by flat, concave or convex walls round a diffraction throat, and which finishes in a mouth and where reflection can occur before or after the diffraction throat, comprising the steps of controlling and regulating acoustic dispersion for the reproduction of wide mid/high frequency bands with a limited horn length, varying form and dimensions of its mouth by means of the simultaneous application of at least two of the acoustic principles, such us diffraction, reflection and absorption, fundamental for the diffusion of sound.

2. Method according to claim 1, wherein the acoustic dispersion is controlled and regulated by modifying the inclination of at least one of the walls forming the waveguide's mouth to vary the diffraction and reflection angle.

3. Method according to claim 1, wherein the acoustic dispersion is controlled and regulated by changing the inclination of at least one of the walls forming the waveguide's mouth to vary reflection and applying deadening material appropriately round the mouth to eliminate the sound waves produced by the diffraction at the edges of the mouth itself.

4. Method according to claim 1, wherein the acoustic dispersion is controlled and regulated by modifying the inclination of at least one of the walls forming the waveguide's mouth to vary the diffraction and applying a deadening material on the shorter edges of the diffraction throat itself.

5. Method according to claim 1, wherein the acoustic dispersion is controlled and regulated by changing the inclination of at least one of the walls forming the mouth to vary reflection and diffraction and applying deadening material round the throat and/or mouth to absorb the sound waves produced by the diffraction at the edges of the throat and/or mouth and the sound waves striking the absorbent material.

6. Waveguide loudspeaker for loudspeaker enclosures including an eventual first duct from a driver throat to a diffraction slot, a second duct from the diffraction slot to a mouth, where the first and/or second duct are formed by flat, concave or convex walls, characterized in that the mouth is folded back in relation to the throat and has dimensions and shape chosen for the simultaneous application of at least two of the three fundamental principles for sound diffusion: diffraction, reflection and absorption.

7. Waveguide loudspeaker according to claim 6, characterized in that the mouth is folded back in relation to the throat and is formed by walls at least one of which has an adjustable inclination to vary and set at least the degree of diffraction and reflection for the reproduction of wide bands of mid/high frequencies with a limited horn or waveguide length.

8. Waveguide loudspeaker according to claim 6, wherein at least one of the walls forming the mouth can be moved to vary its inclination.

9. Waveguide loudspeaker according to claim 6, wherein at least one of the walls forming the mouth has a fixed inclination chosen at the origin and suited to the form and dimension of the loudspeaker enclosure in which the loudspeaker is to be fitted.

10. Waveguide loudspeaker according to claim 8, wherein deadening material is located along the edges of the throat and/or mouth to regulate the absorption of the sound waves produced by the diffraction at the edges of the throat and/or mouth itself and to absorb the sound waves striking the material itself.

11. Waveguide loudspeaker according to claim 6, wherein the convex reflection surface is hyperbolic.

12. Waveguide loudspeaker according to claim 6, wherein the concave reflection surface is parabolic or elliptical.

13. Loudspeaker enclosure characterized in that it includes a loudspeaker or waveguide according to claim 6 and constructed with the method for realizing a loudspeaker or waveguide with the aim of allowing the reproduction of bands of mid/high frequencies with a controlled dispersion, with a loudspeaker enclosure with reduced dimensions.

14. Waveguide loudspeaker according to claim 7, wherein at least one of the walls forming the mouth can be moved to vary its inclination.

15. Waveguide loudspeaker according to claim 7, wherein at least one of the walls forming the mouth has a fixed inclination chosen at the origin and suited to the form and dimension of the loudspeaker enclosure in which the loudspeaker is to be fitted.

16. Waveguide loudspeaker according to claim 9, wherein deadening material is located along the edges of the throat and/or mouth to regulate the absorption of the sound waves produced by the diffraction at the edges of the throat and/or mouth itself and to absorb the sound waves striking the material itself.

17. Loudspeaker enclosure characterized in that it includes a loudspeaker or waveguide according to claim 7 and constructed with the method for realizing a loudspeaker or waveguide with the aim of allowing the reproduction of bands of mid/high frequencies with a controlled dispersion, with a loudspeaker enclosure with reduced dimensions.

18. Loudspeaker enclosure characterized in that it includes a loudspeaker or waveguide according to claim 8 and constructed with the method for realizing a loudspeaker or waveguide with the aim of allowing the reproduction of bands of mid/high frequencies with a controlled dispersion, with a loudspeaker enclosure with reduced dimensions.

19. Loudspeaker enclosure characterized in that it includes a loudspeaker or waveguide according to claim 9 and constructed with the method for realizing a loudspeaker or waveguide with the aim of allowing the reproduction of bands of mid/high frequencies with a controlled dispersion, with a loudspeaker enclosure with reduced dimensions.

20. Loudspeaker enclosure characterized in that it includes a loudspeaker or waveguide according to claim 10 and constructed with the method for realizing a loudspeaker or waveguide with the aim of allowing the reproduction of bands of mid/high frequencies with a controlled dispersion, with a loudspeaker enclosure with reduced dimensions.
